(19) United States
(12) Patent Application Publication
(10) Pub. No.: US 2026/0278918 A1
(43) Pub. Date: Sep. 17, 2026

(54) Systems and Methods for Anti-Aliased Grid-Based Neural Radiance Fields

(71) Applicant: Google LLC, Mountain View, CA (US)

(72) Inventors: Jonathan Tilton Barron, Alameda, CA (US); Benjamin Joseph Mildenhall, San Francisco, CA (US); Dor Verbin, San Francisco, CA (US); Pratul Preeti Srinivasan, San Francisco, CA (US); Lars Peter Johannes Hedman, London (GB)

(21) Appl. No.: 19/168,173

(22) PCT Filed: Dec. 22, 2023
(86) PCT No.: PCT/US2023/085765

§ 371 Date: Sep. 23, 2025

Related U.S. Application Data
(60) Provisional application No. 63/491,865, filed on Mar. 23, 2023.

(51) Int. Cl. G06T 15/20

(52) U.S. Cl. CPC G06T 15/20

(57) ABSTRACT

Provided are systems and methods for anti-aliased grid-based neural radiance fields. Neural Radiance Field (NeRF) training can be accelerated through the use of grid-based representations in the learned mapping from spatial coordinates to colors and volumetric density of the NeRF model. However, these grid-based approaches lack an explicit understanding of scale and therefore often introduce aliasing, usually in the form of jaggies or missing scene content. The present disclosure provides an improved approach for anti-aliasing a NeRF model that yields error rates that are significantly lower than prior techniques and that trains significantly faster than existing approaches.

### CROSS REFERENCE TO RELATED APPLICATIONS

The present application claims filing benefit of U.S. Provisional Patent Application Ser. No. 63/491,865 having a filing date of Mar. 23, 2023, which is incorporated herein by reference in its entirety.

### FIELD

The present disclosure relates generally to machine learning. More particularly, the present disclosure relates to systems and methods for anti-aliased grid-based neural radiance fields.

### BACKGROUND

A neural radiance field (NeRF) model is a machine-learned model that can generate views of a three-dimensional space from multiple two-dimensional views of the space. In the original NeRF model, a multilayer perceptron is trained to parameterize the mapping from spatial coordinates to colors and densities. To render a pixel's color, NeRF casts a ray through that pixel and out into its volumetric representation, queries the MLP for scene properties at samples along that ray, and composites these values into a single color. The original NeRF model is a computationally-intensive algorithm, and complex scenes can take processing times on the order of hours or even days to render.

### SUMMARY

Aspects and advantages of embodiments of the present disclosure will be set forth in part in the following description, or can be learned from the description, or can be learned through practice of the embodiments.

One example aspect of the present disclosure is directed to a computing system, the system includes: one or more processors; and one or more non-transitory computer-readable media that collectively store instructions that, when executed by the one or more processors, cause the computing system to perform operations. The operations include: obtaining a view dataset comprising data descriptive of one or more two-dimensional views of a scene; parameterizing a multidimensional representation of the scene using one or more feature grids; sampling a plurality of samples along a sampling direction of the multidimensional representation according to a multisampling pattern, the multisampling pattern representing a conical frustum; generating one or more isotropic Gaussians based on the plurality of samples; interpolating the one or more isotropic Gaussians into the one or more feature grids to produce a feature set; providing the feature set as input to a proposal model; and generating, based on output of the proposal model, a novel two-dimensional view of the scene.

Another example aspect of the present disclosure is directed to a computer-implemented method for training a view generation model, the method includes: for each of one or more of a plurality of training iterations: obtaining a view position within three-dimensional space; processing data descriptive of the position with a view generation model to generate an output at a location in a novel two-dimensional view of the scene from the view position; evaluating a loss function that compares the output to a ground-truth output, the loss function measuring the distance between a ground truth step function and a step function produced by a proposal model of the view generation model, the loss function being smooth to translation along a ray; and modifying one or more parameter values for one or more parameters of the view generation model based at least in part on the loss function.

Another example aspect of the present disclosure is directed to a computer-implemented method for generating novel two-dimensional views of a scene. The method includes: obtaining a view dataset comprising data descriptive of one or more two-dimensional views of a scene; parameterizing a multidimensional representation of the scene using one or more feature grids; sampling a plurality of samples along a sampling direction of the multidimensional representation according to a multisampling pattern, the multisampling pattern representing a conical frustum; generating one or more isotropic Gaussians based on the plurality of samples; interpolating the one or more isotropic Gaussians into the one or more feature grids to produce a feature set; providing the feature set as input to a proposal model; and generating, based on output of the proposal model, a novel two-dimensional view of the scene.

Other aspects of the present disclosure are directed to various systems, apparatuses, non-transitory computer-readable media, user interfaces, and electronic devices.

These and other features, aspects, and advantages of various embodiments of the present disclosure will become better understood with reference to the following description and appended claims. The accompanying drawings, which are incorporated in and constitute a part of this specification, illustrate example embodiments of the present disclosure and, together with the description, serve to explain the related principles.

### BRIEF DESCRIPTION OF THE DRAWINGS

Detailed discussion of embodiments directed to one of ordinary skill in the art is set forth in the specification, which makes reference to the appended figures, in which:

FIG. 1A depicts a block diagram of an example computing system according to example embodiments of the present disclosure.

FIG. 1B depicts a block diagram of an example computing device according to example embodiments of the present disclosure.

FIG. 1C depicts a block diagram of an example computing device according to example embodiments of the present disclosure.

FIG. 2 depicts a block diagram of an example machine-learned model according to example embodiments of the present disclosure.

FIG. 3 depicts a block diagram of an example machine-learned model according to example embodiments of the present disclosure.

FIG. 4 depicts example strategies for querying a neural graphics model according to example embodiments of the present disclosure.

FIG. 5 depicts example three-dimensional rays divided into frustums denoted by color according to example embodiments of the present disclosure.

FIG. 6 depicts an example visualization of the problem of antialiasing according to example embodiments of the present disclosure.

FIG. 7 depicts an example process for determining a loss function according to example embodiments of the present disclosure.

FIG. 8 depicts example proposal supervision according to example embodiments of the present disclosure.

FIG. 9 depicts plots of functions for converting metric distance into normalized distances according to example embodiments of the present disclosure.

FIG. 10 depicts a flow chart diagram of an example method to perform generation of novel scene views according to example embodiments of the present disclosure.

Reference numerals that are repeated across plural figures are intended to identify the same features in various implementations.

### DETAILED DESCRIPTION

### Overview

Generally, the present disclosure is directed to systems and methods for anti-aliased grid-based neural radiance fields. Neural Radiance Field (NeRF) training can be accelerated through the use of grid-based representations in the learned mapping from spatial coordinates to colors and volumetric density of the NeRF model. However, these grid-based approaches lack an explicit understanding of scale and therefore often introduce aliasing, usually in the form of jaggies or missing scene content. Anti-aliasing has previously been addressed by models such as mip-NeRF 360, which reasons about sub-volumes along a cone rather than points along a ray. Unfortunately, this approach is not natively compatible with current grid-based techniques. The present disclosure provides an improved approach for anti-aliasing a NeRF model that yields error rates that are significantly lower than prior techniques and that trains significantly faster than existing approaches.

In Neural Radiance Fields, a neural network is trained to model a volumetric representation of a 3D scene such that novel views of that scene can be rendered via raytracing. NeRF has proven to be an effective tool for tasks such as view synthesis, generative media, robotics, and computational photography. The original NeRF model used a multilayer perceptron (MLP) to parameterize the mapping from spatial coordinates to colors and densities. Though compact and expressive, MLPs are slow to train. Some existing approaches have used MLPs augmented with voxelated data structures. One example is Instant NGP (iNGP), which uses a pyramid of coarse and fine grids (the finest of which are stored using a hash map) to construct learned features that are processed by a reduced MLP. In addition to being slow, the original NeRF model was also aliased. NeRF reasons about individual points along a ray, which results in so-called “jaggies” or artifacts in rendered images. This aliasing also limits ability of NeRF models to reason about scale. Another existing approach, mip-NeRF casts cones instead of rays and featurizes the entire volume within a conical frustum for use as input to the MLP. Regrettably, the progress made on these two problems of fast training and anti-aliasing are, at first glance, incompatible with each other. This is because mip-NeRF's antialiasing strategy depends critically on the use of positional encoding to featurize a conical frustum into a discrete feature vector, but current grid-based approaches do not use positional encoding, and instead use learned features that are obtained by interpolating into a hierarchy of grids at a single 3D coordinate. Most approaches to anti-aliasing in rendering do not generalize naturally to inverse-rendering in grid-based NeRF models like iNGP. However, the present disclosure leverages ideas from multisampling, statistics, and signal processing to integrate a pyramid of grids into a featurized conical frustum framework.

Mip-NeRF 360 and Instant NGP (iNGP) are both similar to NeRF in that a pixel is rendered by casting a 3D ray and featurizing locations at distances t along the ray, and those features are fed to a neural network whose outputs are alpha-composited to render a color. Training includes repeatedly casting rays corresponding to pixels in training images and minimizing (e.g., via gradient descent) the difference between each pixel's rendered and observed colors. Mip-NeRF 360 and iNGP differ significantly in how coordinates along a ray are parameterized. In mip-NeRF 360, a ray is subdivided into a set of intervals [tᵢ, tᵢ₊₁], each of which represents a conical frustum whose shape is approximated with a multivariate Gaussian, and the expected positional encoding with respect to that Gaussian is used as input to a large MLP. In contrast, iNGP trilinearly interpolates into a hierarchy of differently-sized 3D grids to produce feature vectors for a small MLP.

Naively combining these two approaches introduces two forms of aliasing. First, the feature grid approach (e.g., from iNGP) is incompatible with a scale-aware integrated positional encoding technique (e.g., from mip-NeRF 360), so the features produced by iNGP are aliased with respect to spatial coordinates and thus produce aliased renderings. Second, using iNGP dramatically accelerates training, but this reveals a problem with mip-NeRF 360's online distillation approach that causes highly visible “z-aliasing” (aliasing along a ray), wherein scene content erratically disappears as the camera moves. Mip-NeRF uses features that approximate the integral over the positional encoding of the coordinates within a sub-volume, which in NeRF is a conical frustum along the cone being cast. This results in Fourier features whose amplitudes are small if the period of each sinusoid is larger than the standard deviation of the Gaussian. In particular, the features express the spatial location of the sub-volume only at the wavelengths that are larger than the size of the sub-volume. Because this feature encodes both position and scale, the MLP that consumes it is able to learn a multi-scale representation of the 3D scene that renders anti-aliased images. Grid-based representations like iNGP do not natively allow for sub-volumes to be queried, and instead use trilinear interpolation at a single point to construct features for use in an MLP, which results in learned models that cannot reason about scale or aliasing.

The present disclosure provides a unique solution to this problem by turning each conical frustum into a set of isotropic Gaussians, using a combination of multisampling and feature-downweighting. The anisotropic subvolume is first converted into a set of points that approximate its shape, and then each point is assumed to be an isotropic Gaussian with some scale. This isotropic assumption provides for approximating the true integral of the feature grid over a sub-volume by leveraging the fact that the values in the grid are zero-mean. By averaging these downweighted features, it is possible to obtain scale-aware prefiltered features from an iNGP grid. According to some example aspects of the present disclosure, each pixel corresponds to a cone whose radius is \dot{r}t, where t is metric distance along the ray. Given an interval along the ray [tᵢ, tᵢ₊₁), it is possible to construct a set of multisamples that approximate the shape of that conical frustum according to a multisampling pattern. One example multisampling pattern allots n points along a spiral that makes m loops around the ray's axis and are linearly spaced along t. For instance, one example multisampling pattern is represented by:

$$\{ [ \begin{matrix}\dot{r} t cos ( \frac{2 π mj}{n} ) / 2 \\ \dot{r} t sin ( \frac{2 π mj}{n} ) / 2 \\ t\end{matrix} ] \vert j = 0 , 1 , … ( n - 1 ) \}$$

Here, t=tᵢ+(tᵢ₊₁−tᵢ)(j+½)/n. These 3D coordinates can be rotated into world coordinates by multiplying them by an orthonormal basis whose third vector is the direction of the ray and whose first two vectors are an arbitrary frame that is perpendicular to the view direction, and then shifted by the origin of the ray. When n≥3 and when n and m are co-prime, each set of multisamples can have a sample mean and covariance that match the mean and covariance of each frustum. In some implementations, during training, the model may use a first set of multisamples (e.g., n=7 multisamples) per frustum placed along a spiral that makes some number of loops, such as m=3 loops. Additionally, in some implementations, the multisamples may be randomized rotationally by adding a random value in [0, 2π] to the angular inputs to sin and cos. Furthermore, in some implementations, at test time, the model may use a much second set of multisamples (e.g., a larger set of multisamples, such as n=49 multisamples) on a spiral that makes a second number of loops (e.g., a larger number of loops, such as m=19 loops). Furthermore, in some implementations, there may be no random offsets during test time. These n multisamples {xⱼ} can be used as the means of isotropic Gaussians each with a standard deviation of σⱼ. In particular, σⱼ is set to \dot{r}t scaled by a hyperparameter. If the grids require input coordinates to lie in a bounded domain, a contraction function is applied. Because these Gaussians are isotropic, this contraction can be performed using a simplified and optimized Kalman filter approach.

Though multisampling is an effective tool for reducing aliasing, using naive trilinear interpolation for each multisample may still result in aliasing at high frequencies. To anti-alias interpolation for each individual multisample, the features may be re-weighted at each scale in a way that is inversely-proportional to how each the isotropic Gaussian of each multisample fits within each grid cell. For example, if the Gaussian is much larger than the cell being interpolated into, the interpolated feature is likely unreliable and should be downweighted.

Interpolation into each { [symbol] } at coordinate x is performed by interpolating a set of multisampled isotropic Gaussians with means {xⱼ} and standard deviations {σⱼ}. By reasoning about Gaussian CDFs, it is possible compute the fraction of each Gaussian's PDF that is inside the

$${[ \frac{- 1}{2 n} , \frac{1}{2 n} ]}^{3}$$

cube in [symbol] being interpolated into as a scale-dependent downweighting factor

$${ω}_{j , ℓ} = erf ( 1 / \sqrt{8 {σ}_{j}^{2} {n}_{ℓ}^{2}} ) ,$$

where [symbol] ∈[0, 1]. In some implementations weight decay is imposed on { [symbol] }, which encourages the values in [symbol] to be normally distributed and zero-mean. This zero-mean assumption provides for approximating the expected grid feature with respect to each multisample Gaussian as wⱼ· [symbol] +(1−ωⱼ)·0=ωⱼ· [symbol] . Thus, it is possible to approximate the expected feature corresponding to the conical frustum being featurized by taking a weighted mean of each multisample's interpolated features: [symbol] =meanⱼ( [symbol] ·trilerp( [symbol] ·xⱼ; [symbol] )). This set of features {f [symbol] } is concatenated and provided as input to an MLP. Featurized versions of { [symbol] } are also concatenated.

Although the previously-described multisampling and downweighting approach is an effective way to reduce spatial aliasing, there is an additional source of aliasing along the ray that must be considered, referred to as z-aliasing. Z-aliasing occurs due to the use of a proposal MLP that learns to produce upper bounds on scene geometry. During training and rendering, intervals along a ray are repeatedly evaluated by this proposal MLP to generate histograms that are resampled by the next round of sampling, and only the final set of samples is rendered by the MLP. This approach significantly improves speed and rendering quality compared to prior strategies of learning one or more NeRFs that are all supervised using image reconstruction. However, the proposal MLP intends to learn a non-smooth mapping from input coordinates to output volumetric densities. This results in artifacts in which a ray “skips” scene content. It is theorized that the root cause of z-aliasing in is the “interlevel loss” used to supervise the proposal network, which assigns an equivalent loss to NeRF and proposal histogram bins whether their overlap is partial or complete, and proposal histogram bins are only penalized when they completely fail to overlap.

The present disclosure provides an alternative loss that, unlike the interlevel loss, is continuous and smooth with respect to distance along the ray. To produce a loss function that is smooth with respect to distance along the ray, first consider a technique for turning a piecewise constant step function into a continuous piecewise-linear function. Smoothing a discrete 1D signal is trivial, and requires just discrete convolution with a box filter (or a Gaussian filter, etc.). But this problem becomes difficult when dealing with piecewise constant functions whose endpoints are continuous, as the endpoints of each interval in the step function may be at any location. Rasterizing the step function and performing convolution is not a viable solution, as this fails in the common case of extremely narrow histogram bins. A new algorithm is therefore required. Consider a step function (x, y) where (xᵢ, xᵢ₊₁) are the endpoints of interval i and yᵢ is the value of the step function inside interval i. This step function should be convolved with a rectangular pulse with radius r that integrates to 1 (e.g., [|x|<r]/(2r) where [ ] are Iverson brackets). Observe that the convolution of a single interval i of a step function with this rectangular pulse is a piecewise linear trapezoid with knots at (xᵢ−r, 0), (xᵢ+r, yᵢ), (xₜ₊₁−r, yᵢ), (xᵢ₊₁+r, 0), and that a piecewise linear spline is the double integral of scaled delta functions located at each spline knot. Following this, it is possible to efficiently convolve a step function with a rectangular pulse as follows. First, turn each endpoint xᵢ of the step function into two signed delta functions located at xᵢ−r and xᵢ+r with values that are proportional to the change between adjacent y values. Next, interleave (e.g., via sorting) those delta functions. Finally, integrate those sorted delta functions twice.

The proposal supervision approach can include a loss function that takes as input a step function produced by the NeRF (s, w) and a similar step function produced by the proposal model (ŝ, ŵ). Both of these step functions are histograms, where s and ŝ are vectors of endpoint locations while w and ŵ are vectors of weights that sum to ≤1, and where wᵢ denotes how visible scene content is for interval i of the step function. Each sᵢ is a normalized function of true metric distance tᵢ, according to a normalization function g(·). Note that s and ŝ are not necessarily the same, as the endpoints of each histogram may be distinct. To train a proposal network to bound the scene geometry predicted by the NeRF without introducing aliasing, the loss function may measure the distance between (s, w) and (ŝ, ŵ) that is smooth with respect to translation along the ray, despite the challenge that the endpoints of both step functions are different. To do this, the NeRF histogram (s, w) is blurred using the anti-aliased loss function, and then that blurred distribution is resampled into the set of intervals of the proposal histogram s to produce a new set of histogram weights w^{ŝ}. After resampling the blurred NeRF weights into the space of the proposal histogram, the loss function is an element-wise function of w^{ŝ} and ŵ:

$${ℒ}_{prop} ( s , w , \hat{s} , \hat{w} ) = {\sum }_{i} \frac{1}{{\hat{ω}}_{i}} max ( 0 , ∇ ( {ω}_{i}^{\hat{s}} ) - {\hat{ω}}_{i} )$$

Though this loss resembles a halfquadratic chi-squared loss with a stop-gradient, the blurring and resampling used to generate w^{ŝ} prevents aliasing.

Metric distance is parameterized along a ray t∈[tₙₑₐᵣ, t_{far}] in terms of normalized distance s∈[0, 1], where tₙₑₐᵣ and t_{far} are manually-defined near and far plane distances. Rendering can use metric distance t. Resampling and proposal supervision can use normalized distance s. A bijection function g(·) can define a bijection between the two. In some implementations, a power transformation is used as a normalization. One example power transformation is given by:

$$𝒫 ( x , λ ) = \frac{\vert λ - 1 \vert}{λ} ( {( \frac{x}{\vert λ - 1 \vert} + 1 )}^{λ} ) - 1$$

The slope of this power transformation at the origin is 1, so normalized distance near the ray origin is proportional to metric distance which obviates the need to tune a non-zero near plane distance tₙₑₐᵣ. However, farther from the origin, the metric distance becomes curved to resemble log-distance (λ=0) or inverse-distance (λ=−1). This provides for smoothly interpolating between different normalizations instead of swapping in different discrete functions.

Example aspects of the present disclosure may be implemented by a computing system including one or more processors and one or more non-transitory computer-readable media that collectively store instructions that, when executed by the one or more processors, cause the computing system to perform operations. The operations can cause the computing system to perform any of the methods or processes described herein.

As one example, a computing system can obtain a view dataset including data descriptive of one or more two-dimensional views of a scene. For instance, the data descriptive of one or more two-dimensional views of a scene can include one or more images of at least a portion of the scene. As an example, the view dataset may depict a scene from several angles, heights, perspectives, and other various positions. In some cases, the view dataset may depict a scene nearly completely, but may not include data from all positions.

The computing system can parameterize a multidimensional representation of the scene using one or more feature grids. For instance, the multidimensional representation may be a three-dimensional representation according to a three-dimensional grid or tensor. The one or more feature grids may include one or more feature grids having a first resolution and one or more feature grids having a second resolution. For instance, some of the feature grids may have a coarser (e.g., lower) resolution and some of the feature grids may have a finer (e.g., higher) resolution. The one or more feature grids may additionally include or describe features that approximate an integral over positional encoding of a conical frustum used to trace a pixel through the multidimensional representation, as described herein.

The computing system can sample a plurality of samples along a sampling direction of the multidimensional representation according to a multisampling pattern. The multisampling pattern can represent a conical frustum. In particular, in some implementations, the multisampling pattern can include a number of points along one or more loops around an axis defined by the sampling direction. In some implementations, the multisampling pattern can include at least one of a greater number of points or a greater number of loops at inference than at training. One example multisampling pattern is represented by:

$$\{ [ \begin{matrix}\dot{r} t cos ( \frac{2 π mj}{n} ) / 2 \\ \dot{r} t sin ( \frac{2 π mj}{n} ) / 2 \\ t\end{matrix} ] \vert j = 0 , 1 , … ( n - 1 ) \}$$

The computing system can generate one or more isotropic Gaussians based on the plurality of samples. In some implementations, generating the one or more isotropic Gaussians includes providing each of the plurality of samples as a mean of an isotropic Gaussian of the one or more isotropic Gaussians, wherein a standard deviation of the isotropic Gaussian is based on a radius of the conical frustum.

The computing system can interpolate the one or more isotropic Gaussians into the one or more feature grids to produce a feature set. In some implementations, interpolating the one or more isotropic Gaussians includes downweighting the one or more isotropic Gaussians based on a scale-dependent downweighing factor. The scale-dependent downweighting factor can be based on a size difference between an isotropic Gaussian of the one or more isotropic Gaussians and a size of a cell in the one or more feature grids that the isotropic Gaussian is being interpolated into.

The computing system can provide the feature set as input to a proposal model and generate, based on output of the proposal model, a novel two-dimensional view of the scene. The proposal model may be any suitable model, such as a multilayer perceptron (MLP) or neural network. In some implementations, the proposal model is trained using a loss function that is smooth along the sampling direction. The loss function may additionally be a quadratic chi-squared loss with a stop-gradient formed by convolving a step function with a rectangular pulse.

The computing system can additionally perform a computer-implemented method for training a view generation model. The method can include, for each of one or more of a plurality of training iterations: obtaining a view position within three-dimensional space; processing data descriptive of the position with a view generation model to generate an output at a location in a novel two-dimensional view of the scene from the view position; evaluating a loss function that compares the output to a ground-truth output, the loss function measuring the distance between a ground truth step function and a step function produced by a proposal model of the view generation model, the loss function being smooth to translation along a ray; and modifying one or more parameter values for one or more parameters of the view generation model based at least in part on the loss function. In some implementations, the multisampling pattern can include a number of points along one or more loops around an axis defined by the sampling direction, and wherein the number of points or a number of the one or more loops is fewer than that of a second number of points or a second number of loops at inference. In some implementations, the loss function includes a step function wherein the endpoints of the step function are replaced with two signed delta functions that have been interleaved and integrated twice.

Example aspects of the present disclosure provide a number of technical effects and benefits, including improvements to computing technology. As one example, example aspects of the present disclosure provide a novel approach for a computing system (e.g., a computing system including one or more computing devices) to generate novel views of a scene based on a finite set of two-dimensional views of the scene. Furthermore, the present disclosure provides for improved accuracy in the generated novel views. For instance, example aspects of the present disclosure provide a reduced occurrence of aliasing and related artifacts (e.g., “jaggies”) in generated views. Additionally or alternatively, example aspects of the present disclosure provide for generated views that more closely resemble an ideal (e.g., ground truth) view. Furthermore, the present disclosure provides for reduced training time and/or resources compared to existing approaches. For instance, systems and methods according to the present disclosure can require fewer computing resources to train a model for generating novel views of a scene compared to existing resources. Additionally or alternatively, systems and methods according to the present disclosure can better optimize a tradeoff between training time/model complexity and accuracy than existing approaches.

With reference now to the Figures, example embodiments of the present disclosure will be discussed in further detail.

### Example Devices and Systems

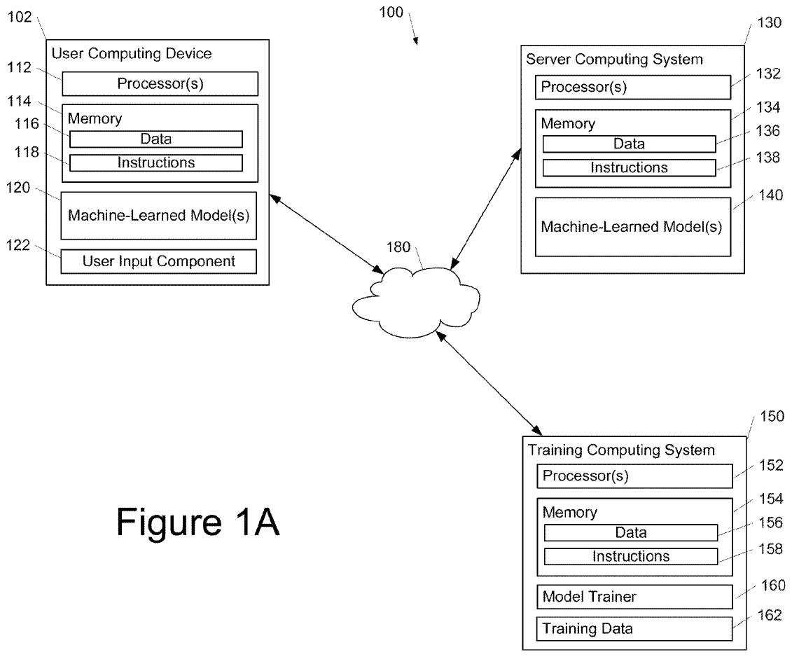

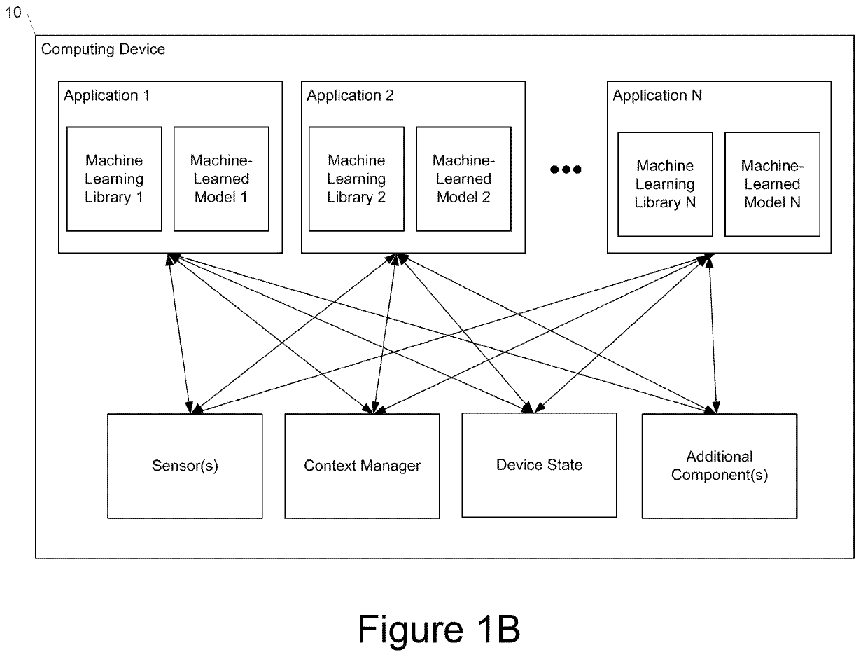

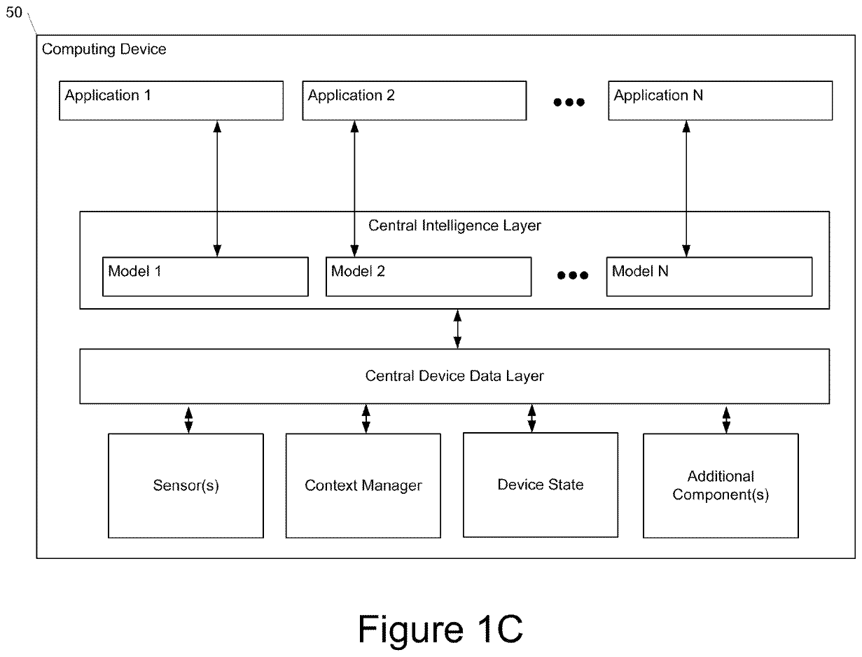

FIG. 1A depicts a block diagram of an example computing system 100 that performs generation of novel views according to example embodiments of the present disclosure. The system 100 includes a user computing device 102, a server computing system 130, and a training computing system 150 that are communicatively coupled over a network 180.

The user computing device 102 can be any type of computing device, such as, for example, a personal computing device (e.g., laptop or desktop), a mobile computing device (e.g., smartphone or tablet), a gaming console or controller, a wearable computing device, an embedded computing device, or any other type of computing device.

The user computing device 102 includes one or more processors 112 and a memory 114. The one or more processors 112 can be any suitable processing device (e.g., a processor core, a microprocessor, an ASIC, an FPGA, a controller, a microcontroller, etc.) and can be one processor or a plurality of processors that are operatively connected. The memory 114 can include one or more non-transitory computer-readable storage media, such as RAM, ROM, EEPROM, EPROM, flash memory devices, magnetic disks, etc., and combinations thereof. The memory 114 can store data 116 and instructions 118 which are executed by the processor 112 to cause the user computing device 102 to perform operations.

In some implementations, the user computing device 102 can store or include one or more machine-learned models 120. For example, the machine-learned models 120 can be or can otherwise include various machine-learned models such as neural networks (e.g., deep neural networks) or other types of machine-learned models, including non-linear models and/or linear models. Neural networks can include feed-forward neural networks, recurrent neural networks (e.g., long short-term memory recurrent neural networks), convolutional neural networks or other forms of neural networks. Some example machine-learned models can leverage an attention mechanism such as self-attention. For example, some example machine-learned models can include multi-headed self-attention models (e.g., transformer models).

In some implementations, the one or more machine-learned models 120 can be received from the server computing system 130 over network 180, stored in the user computing device memory 114, and then used or otherwise implemented by the one or more processors 112. In some implementations, the user computing device 102 can implement multiple parallel instances of a single machine-learned model 120.

Additionally or alternatively, one or more machine-learned models 140 can be included in or otherwise stored and implemented by the server computing system 130 that communicates with the user computing device 102 according to a client-server relationship. For example, the machine-learned models 140 can be implemented by the server computing system 140 as a portion of a web service. Thus, one or more models 120 can be stored and implemented at the user computing device 102 and/or one or more models 140 can be stored and implemented at the server computing system 130.

The user computing device 102 can also include one or more user input components 122 that receives user input. For example, the user input component 122 can be a touch-sensitive component (e.g., a touch-sensitive display screen or a touch pad) that is sensitive to the touch of a user input object (e.g., a finger or a stylus). The touch-sensitive component can serve to implement a virtual keyboard. Other example user input components include a microphone, a traditional keyboard, or other means by which a user can provide user input.

The server computing system 130 includes one or more processors 132 and a memory 134. The one or more processors 132 can be any suitable processing device (e.g., a processor core, a microprocessor, an ASIC, an FPGA, a controller, a microcontroller, etc.) and can be one processor or a plurality of processors that are operatively connected. The memory 134 can include one or more non-transitory computer-readable storage media, such as RAM, ROM, EEPROM, EPROM, flash memory devices, magnetic disks, etc., and combinations thereof. The memory 134 can store data 136 and instructions 138 which are executed by the processor 132 to cause the server computing system 130 to perform operations.

In some implementations, the server computing system 130 includes or is otherwise implemented by one or more server computing devices. In instances in which the server computing system 130 includes plural server computing devices, such server computing devices can operate according to sequential computing architectures, parallel computing architectures, or some combination thereof.

As described above, the server computing system 130 can store or otherwise include one or more machine-learned models 140. For example, the models 140 can be or can otherwise include various machine-learned models. Example machine-learned models include neural networks or other multi-layer non-linear models. Example neural networks include feed forward neural networks, deep neural networks, recurrent neural networks, and convolutional neural networks. Some example machine-learned models can leverage an attention mechanism such as self-attention. For example, some example machine-learned models can include multi-headed self-attention models (e.g., transformer models).

The user computing device 102 and/or the server computing system 130 can train the models 120 and/or 140 via interaction with the training computing system 150 that is communicatively coupled over the network 180. The training computing system 150 can be separate from the server computing system 130 or can be a portion of the server computing system 130.

The training computing system 150 includes one or more processors 152 and a memory 154. The one or more processors 152 can be any suitable processing device (e.g., a processor core, a microprocessor, an ASIC, an FPGA, a controller, a microcontroller, etc.) and can be one processor or a plurality of processors that are operatively connected. The memory 154 can include one or more non-transitory computer-readable storage media, such as RAM, ROM, EEPROM, EPROM, flash memory devices, magnetic disks, etc., and combinations thereof. The memory 154 can store data 156 and instructions 158 which are executed by the processor 152 to cause the training computing system 150 to perform operations. In some implementations, the training computing system 150 includes or is otherwise implemented by one or more server computing devices.

The training computing system 150 can include a model trainer 160 that trains the machine-learned models 120 and/or 140 stored at the user computing device 102 and/or the server computing system 130 using various training or learning techniques, such as, for example, backwards propagation of errors. For example, a loss function can be backpropagated through the model(s) to update one or more parameters of the model(s) (e.g., based on a gradient of the loss function). Various loss functions can be used such as mean squared error, likelihood loss, cross entropy loss, hinge loss, and/or various other loss functions. Gradient descent techniques can be used to iteratively update the parameters over a number of training iterations.

In some implementations, performing backwards propagation of errors can include performing truncated backpropagation through time. The model trainer 160 can perform a number of generalization techniques (e.g., weight decays, dropouts, etc.) to improve the generalization capability of the models being trained.

In particular, the model trainer 160 can train the machine-learned models 120 and/or 140 based on a set of training data 162. The training data 162 can include, for example, a view dataset including data descriptive of one or more two-dimensional views of a scene. As one example, the view dataset can include one or more images depicting the scene captured at different angles or positions.

In some implementations, if the user has provided consent, the training examples can be provided by the user computing device 102. Thus, in such implementations, the model 120 provided to the user computing device 102 can be trained by the training computing system 150 on user-specific data received from the user computing device 102. In some instances, this process can be referred to as personalizing the model.

The model trainer 160 includes computer logic utilized to provide desired functionality. The model trainer 160 can be implemented in hardware, firmware, and/or software controlling a general purpose processor. For example, in some implementations, the model trainer 160 includes program files stored on a storage device, loaded into a memory and executed by one or more processors. In other implementations, the model trainer 160 includes one or more sets of computer-executable instructions that are stored in a tangible computer-readable storage medium such as RAM, hard disk, or optical or magnetic media.

The network 180 can be any type of communications network, such as a local area network (e.g., intranet), wide area network (e.g., Internet), or some combination thereof and can include any number of wired or wireless links. In general, communication over the network 180 can be carried via any type of wired and/or wireless connection, using a wide variety of communication protocols (e.g., TCP/IP, HTTP, SMTP, FTP), encodings or formats (e.g., HTML, XML), and/or protection schemes (e.g., VPN, secure HTTP, SSL).

In some implementations, the input to the machine-learned model(s) of the present disclosure can be image data. The machine-learned model(s) can process the image data to generate an output. As an example, the machine-learned model(s) can process the image data to generate an image recognition output (e.g., a recognition of the image data, a latent embedding of the image data, an encoded representation of the image data, a hash of the image data, etc.). As another example, the machine-learned model(s) can process the image data to generate an image segmentation output. As another example, the machine-learned model(s) can process the image data to generate an image classification output. As another example, the machine-learned model(s) can process the image data to generate an image data modification output (e.g., an alteration of the image data, etc.). As another example, the machine-learned model(s) can process the image data to generate an encoded image data output (e.g., an encoded and/or compressed representation of the image data, etc.). As another example, the machine-learned model(s) can process the image data to generate an upscaled image data output. As another example, the machine-learned model(s) can process the image data to generate a prediction output. As another example, the machine-learned model(s) can process the image data to generate novel views of scenes depicted in the image data.

FIG. 1A illustrates one example computing system that can be used to implement the present disclosure. Other computing systems can be used as well. For example, in some implementations, the user computing device 102 can include the model trainer 160 and the training dataset 162. In such implementations, the models 120 can be both trained and used locally at the user computing device 102. In some of such implementations, the user computing device 102 can implement the model trainer 160 to personalize the models 120 based on user-specific data.

FIG. 1B depicts a block diagram of an example computing device 10 that performs according to example embodiments of the present disclosure. The computing device 10 can be a user computing device or a server computing device.

The computing device 10 includes a number of applications (e.g., applications 1 through N). Each application contains its own machine learning library and machine-learned model(s). For example, each application can include a machine-learned model. Example applications include a text messaging application, an email application, a dictation application, a virtual keyboard application, a browser application, etc.

As illustrated in FIG. 1B, each application can communicate with a number of other components of the computing device, such as, for example, one or more sensors, a context manager, a device state component, and/or additional components. In some implementations, each application can communicate with each device component using an API (e.g., a public API). In some implementations, the API used by each application is specific to that application.

FIG. 1C depicts a block diagram of an example computing device 50 that performs according to example embodiments of the present disclosure. The computing device 50 can be a user computing device or a server computing device.

The computing device 50 includes a number of applications (e.g., applications 1 through N). Each application is in communication with a central intelligence layer. Example applications include a text messaging application, an email application, a dictation application, a virtual keyboard application, a browser application, etc. In some implementations, each application can communicate with the central intelligence layer (and model(s) stored therein) using an API (e.g., a common API across all applications).

The central intelligence layer includes a number of machine-learned models. For example, as illustrated in FIG. 1C, a respective machine-learned model can be provided for each application and managed by the central intelligence layer. In other implementations, two or more applications can share a single machine-learned model. For example, in some implementations, the central intelligence layer can provide a single model for all of the applications. In some implementations, the central intelligence layer is included within or otherwise implemented by an operating system of the computing device 50.

The central intelligence layer can communicate with a central device data layer. The central device data layer can be a centralized repository of data for the computing device 50. As illustrated in FIG. 1C, the central device data layer can communicate with a number of other components of the computing device, such as, for example, one or more sensors, a context manager, a device state component, and/or additional components. In some implementations, the central device data layer can communicate with each device component using an API (e.g., a private API).

### Example Model Arrangements

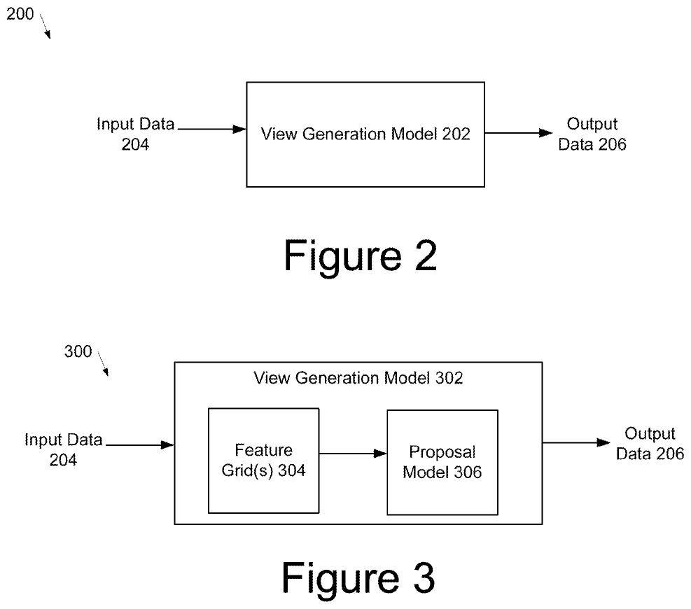

FIG. 2 depicts a block diagram of an example machine-learned model 200 according to example embodiments of the present disclosure. In some implementations, the machine-learned model 200 is trained to receive a set of input data 204 descriptive of a view dataset including data descriptive of one or more two-dimensional views of a scene and, as a result of receipt of the input data 204, provide output data 206 that includes a novel two-dimensional view of the scene. Thus, in some implementations, the machine-learned model 200 can include a view generation model 202 that is operable to generate novel views of a scene based on a dataset of existing views of the scene, as described further herein.

FIG. 3 depicts a block diagram of an example machine-learned model 300 according to example embodiments of the present disclosure. The machine-learned model 300 is similar to the machine-learned model 200 of FIG. 2 except that model 300 further includes a view generation model 302 having one or more feature grid(s) 304 and a proposal model 306. As described herein, the view generation model 302 can parameterize a scene according to the feature grids 304 and provide feature sets corresponding to the feature grids 304 as input to the proposal model 306. The feature grids 304 can have varying resolutions, such as coarse resolutions and/or fine resolutions. From the feature sets, the proposal model 306 can generate the output data 206. The proposal model 306 may be a multilayer perceptron. In some implementations, the proposal model 306 may be a smaller MLP (e.g., having fewer layers, nodes, etc.) than a MLP used in other view generation models, such as NeRF models.

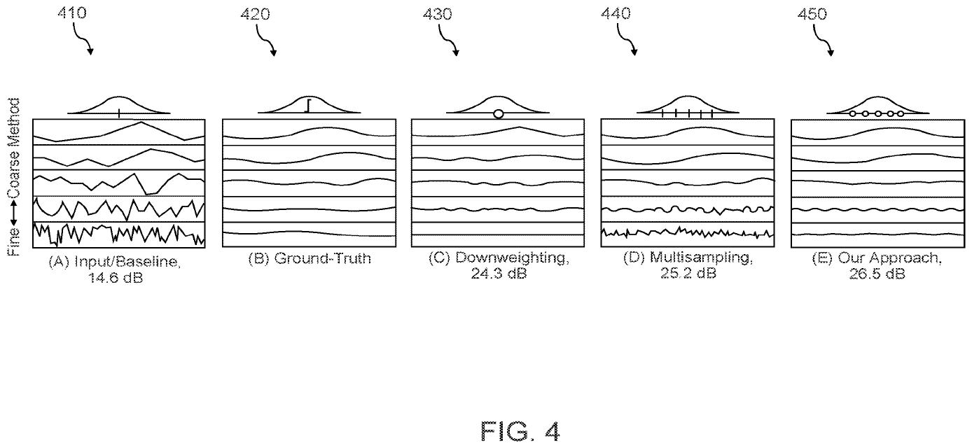

FIG. 4 depicts example strategies for querying a neural graphics model (e.g., an iNGP model) according to example embodiments of the present disclosure. Each of the subplots represents a different strategy for querying the NGP at all coordinates along the x axis. For instance, consider that a Gaussian moves from left to right along the plots, where each line is the NGP feature for each coordinate and each shading represents a different scale. Plot 410 depicts the naïve solution of querying the Gaussian's mean at each point. This results in features with piecewise-linear kinks, where the high frequencies past the bandwidth of the Gaussian are large and inaccurate. Plot 420 depicts the “true” or mathematically accurate solution, obtained by convolving the NGP features with a Gaussian. The result is that features at coarser resolutions are smooth but informative, and features at fine resolutions are near zero. Unfortunately, this solution is intractable in practice. Plot 430 depicts a solution for suppressing unreliable high frequencies by downweighting them based on the scale of the Gaussian. Shaded bands behind each feature indicate the downweighting. This alone, however, results in sharp discontinuities in features at coarser resolutions. Plot 440 depicts an alternative solution, supersampling. Supersampling produces reasonable coarse scale features but erratic fine scale features. Finally, plot 450 illustrates an approach according to example aspects of the present disclosure, where isotropic sub-Gaussians are multisampled, and each sub-Gaussian's scale is used to downweight frequencies. As illustrated, this approach produces smooth and informative features at coarser scales, and lower-amplitude features at finer resolutions. This approach is close to the ground-truth example of plot 420, but is crucially tractable in practice and trains faster than some existing approaches.

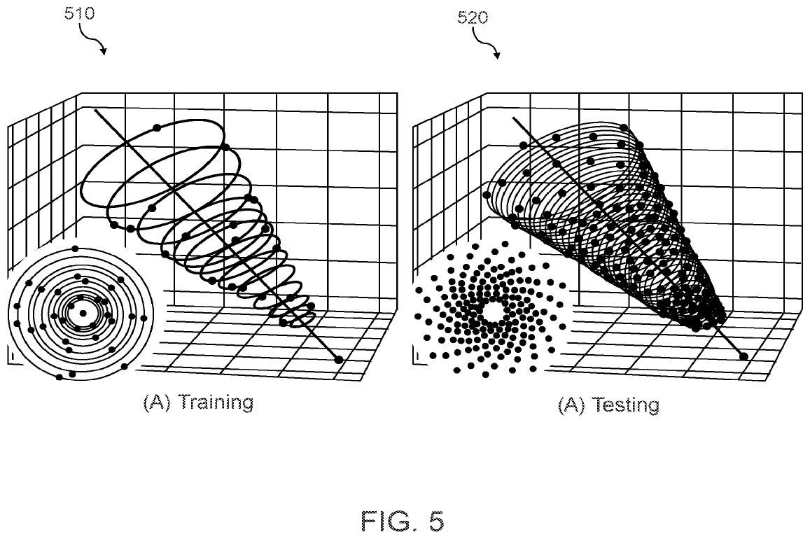

FIG. 5 depicts example three-dimensional rays divided into frustums denoted by color according to example embodiments of the present disclosure. For instance, the three-dimensional rays of FIG. 5 may represent sampling directions. The examples of FIG. 5 depict the rays having exaggerated pixel width for the purposes of illustration. Each frustum may be multisampled by placing points (e.g., n points) along a spiral with a number of loops (e.g., m loops) such that the sample mean and covariance matches the frustum's true mean and covariance. Ray 510 depicts an example ray that may be used in training, which may have a smaller, randomized set of multisamples for each frustum. Ray 520, alternatively, depicts an example ray that may be used at inference or testing, with a larger, deterministic set of multisamples.

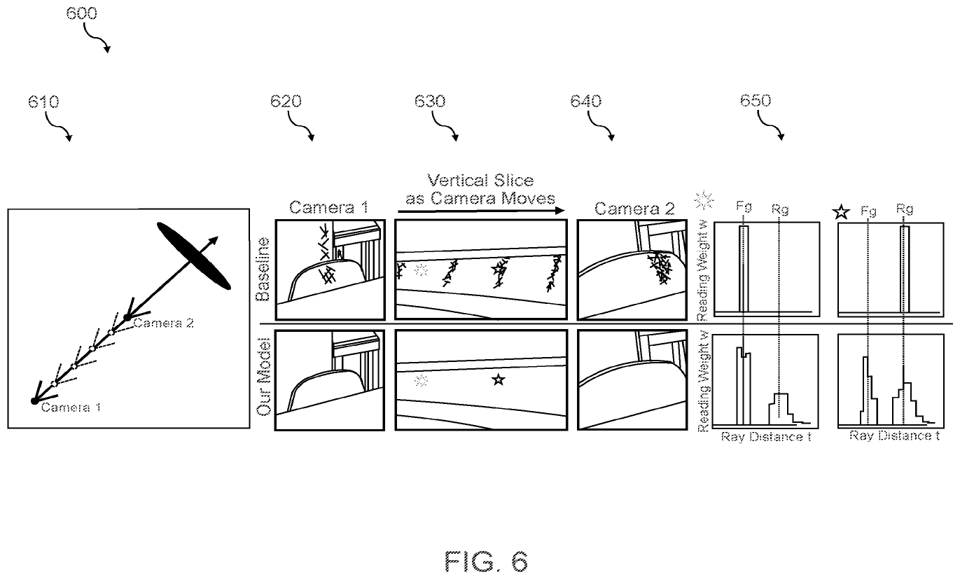

FIG. 6 depicts an example visualization 600 of the problem of antialiasing according to example embodiments of the present disclosure. Scenario 610 depicts an example scene where two training cameras face a narrow red chair in front of a gray wall. The images 620, 630, and 640 depict example slices as a test camera is swept between the two training cameras. As illustrated in the top set of images, the conventional baseline algorithm will “miss” or “hit” the chair depending on distance, therefore introducing tearing artifacts at each image. Alternatively, as illustrated in the bottom set of images, a model according to example aspects of the present disclosure correctly perceives the chair at all distances, so no artifacts are present in the generated images. As illustrated in the distributions 650, the baseline model has learned non-smooth proposal distributions due to aliasing in its supervision, while the model according to example aspects of the present disclosure has learned proposal distributions that capture both the foreground and background at all depths.

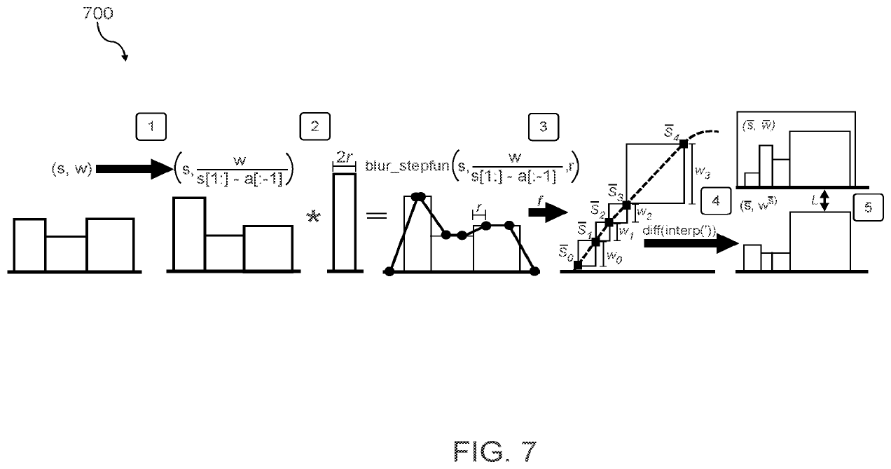

FIG. 7 depicts an example process 700 for determining a loss function according to example embodiments of the present disclosure. According to example aspects of the present disclosure, one example loss function that mitigates the effect of aliasing when used with a model as described herein is created by smoothing and resampling a NeRF histogram (s, w) into the same set of endpoints as a proposal histogram (ŝ, ŵ). As depicted in step 1, w is divided by the size of each interval in s to yield a piecewise constant probability density function (PDF) that integrates to less than or equal to one. At step 2, that PDF is convolved with a rectangular pulse to obtain a piecewise-quadratic CDF that is queried via piecewise quadratic interpolation at each location in s. At step 4, the NeRF histogram weights w resampled into the endpoints of the proposal histogram ŝ, or w^{ŝ}, are obtained by taking the difference between adjacent interpolated values. Finally, at step 5, the loss [symbol] is evaluated as an element-wise function of w^{ŝ} and w, as they share a common coordinate space.

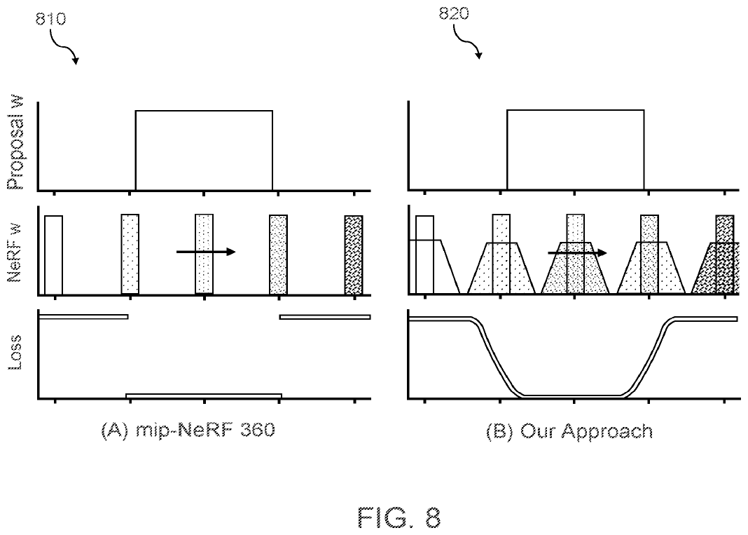

FIG. 8 depicts example proposal supervision for a simple setting where a narrow NeRF histogram, in the middle plot, translates along a ray relative to a coarse proposal histogram, in the top plot, and the resulting loss in the bottom plot. As illustrated in plot 810, which corresponds to a conventional model, for example, the mip-NeRF 360 model, the loss is piecewise constant. This piecewise constant loss can contribute to aliasing in model outputs. However, as illustrated in plot 820, which corresponds to a prefiltered smooth loss created by blurring NeRF histograms into piecewise linear splines (e.g., as discussed with respect to FIG. 7), the loss is continuous over all translations. This, in turn, reduces aliasing in final model outputs.

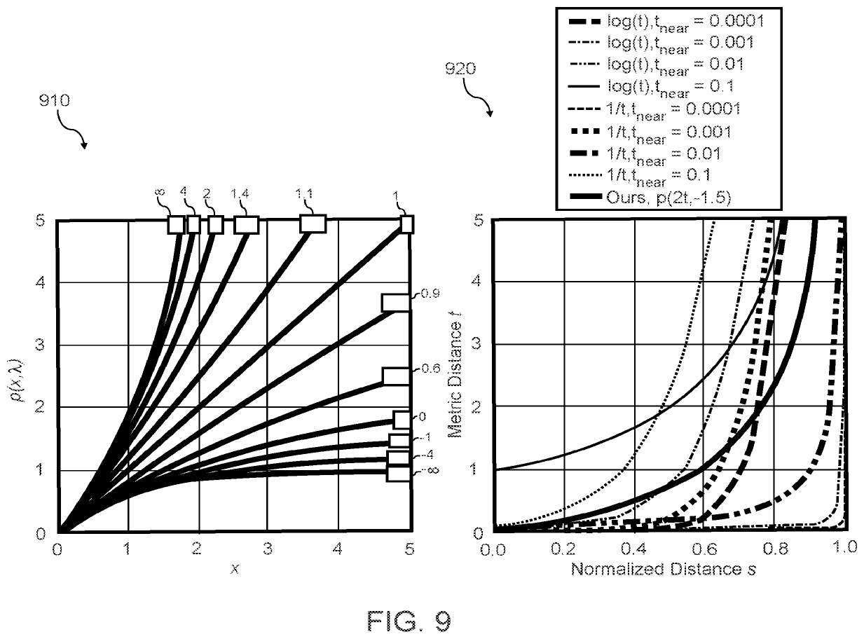

FIG. 9 depicts plots of functions for converting metric distance into normalized distances according to example embodiments of the present disclosure. In particular, plot 910 depicts a power transformation given by:

$$𝒫 ( x , λ ) = \frac{\vert λ - 1 \vert}{λ} ( {( \frac{x}{\vert λ - 1 \vert} + 1 )}^{λ} ) - 1$$

This power transformation provides for interpolating between common curves such as linear curves, logarithmic curves, and inverse curves by modifying λ, while retaining a linear-like shape near the origin. Plot 920 depicts curves that may be constructed using this power transformation. As illustrated, these curves transition from linear to inverse or inverse-square, which support scene content close to the camera.

### Example Methods

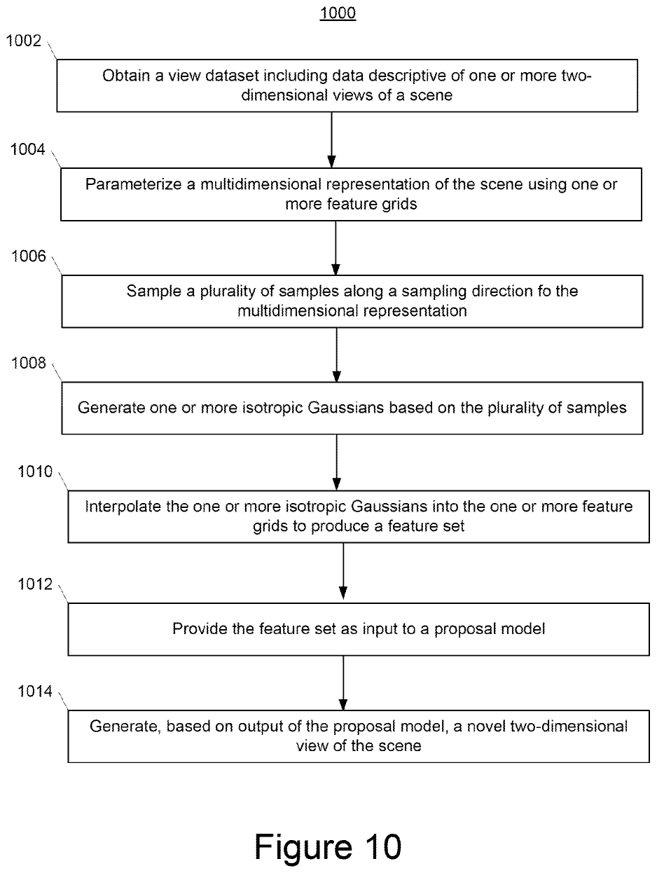

FIG. 10 depicts a flow chart diagram of an example method to perform generation of novel scene views according to example embodiments of the present disclosure. Although FIG. 10 depicts steps performed in a particular order for purposes of illustration and discussion, the methods of the present disclosure are not limited to the particularly illustrated order or arrangement. The various steps of the method 1000 can be omitted, rearranged, combined, and/or adapted in various ways without deviating from the scope of the present disclosure.

At 1002, a computing system (e.g., a computing system including one or more computing devices) can obtain a view dataset including data descriptive of one or more two-dimensional views of a scene. For instance, the data descriptive of one or more two-dimensional views of a scene can include one or more images of at least a portion of the scene. As an example, the view dataset may depict a scene from several angles, heights, perspectives, and other various positions. In some cases, the view dataset may depict a scene nearly completely, but may not include data from all positions.

At 1004, the computing system can parameterize a multidimensional representation of the scene using one or more feature grids. For instance, the multidimensional representation may be a three-dimensional representation according to a three-dimensional grid or tensor. The one or more feature grids may include one or more feature grids having a first resolution and one or more feature grids having a second resolution. For instance, some of the feature grids may have a coarser (e.g., lower) resolution and some of the feature grids may have a finer (e.g., higher) resolution. The one or more feature grids may additionally include or describe features that approximate an integral over positional encoding of a conical frustum used to trace a pixel through the multidimensional representation, as described herein.

At 1006, the computing system can sample a plurality of samples along a sampling direction of the multidimensional representation according to a multisampling pattern. The multisampling pattern can represent a conical frustum. In particular, in some implementations, the multisampling pattern can include a number of points along one or more loops around an axis defined by the sampling direction. In some implementations, the multisampling pattern can include at least one of a greater number of points or a greater number of loops at inference than at training. One example multisampling pattern is represented by:

$$\{ [ \begin{matrix}\dot{r} t cos ( \frac{2 π mj}{n} ) / 2 \\ \dot{r} t sin ( \frac{2 π mj}{n} ) / 2 \\ t\end{matrix} ] \vert j = 0 , 1 , … ( n - 1 ) \}$$

At 1008, the computing system can generate one or more isotropic Gaussians based on the plurality of samples. In some implementations, generating the one or more isotropic Gaussians includes providing each of the plurality of samples as a mean of an isotropic Gaussian of the one or more isotropic Gaussians, wherein a standard deviation of the isotropic Gaussian is based on a radius of the conical frustum.

At 1010, the computing system can interpolate the one or more isotropic Gaussians into the one or more feature grids to produce a feature set. In some implementations, interpolating the one or more isotropic Gaussians includes downweighting the one or more isotropic Gaussians based on a scale-dependent downweighing factor. The scale-dependent downweighting factor can be based on a size difference between an isotropic Gaussian of the one or more isotropic Gaussians and a size of a cell in the one or more feature grids that the isotropic Gaussian is being interpolated into.

At 1012, the computing can provide the feature set as input to a proposal model. At 1014, the computing system can generate, based on output of the proposal model, a novel two-dimensional view of the scene. The proposal model may be any suitable model, such as a multilayer perceptron (MLP) or neural network. In some implementations, the proposal model is trained using a loss function that is smooth along the sampling direction. The loss function may additionally be a quadratic chi-squared loss with a stop-gradient formed by convolving a step function with a rectangular pulse.

### ADDITIONAL DISCLOSURE

The technology discussed herein makes reference to servers, databases, software applications, and other computer-based systems, as well as actions taken and information sent to and from such systems. The inherent flexibility of computer-based systems allows for a great variety of possible configurations, combinations, and divisions of tasks and functionality between and among components. For instance, processes discussed herein can be implemented using a single device or component or multiple devices or components working in combination. Databases and applications can be implemented on a single system or distributed across multiple systems. Distributed components can operate sequentially or in parallel.

While the present subject matter has been described in detail with respect to various specific example embodiments thereof, each example is provided by way of explanation, not limitation of the disclosure. Those skilled in the art, upon attaining an understanding of the foregoing, can readily produce alterations to, variations of, and equivalents to such embodiments. Accordingly, the subject disclosure does not preclude inclusion of such modifications, variations and/or additions to the present subject matter as would be readily apparent to one of ordinary skill in the art. For instance, features illustrated or described as part of one embodiment can be used with another embodiment to yield a still further embodiment. Thus, it is intended that the present disclosure cover such alterations, variations, and equivalents.

1. A computing system, the system comprising:
one or more processors; and
one or more non-transitory computer-readable media that collectively store instructions that, when executed by the one or more processors, cause the computing system to perform operations, the operations comprising:
obtaining a view dataset comprising data descriptive of one or more two-dimensional views of a scene;
parameterizing a multidimensional representation of the scene using one or more feature grids;
sampling a plurality of samples along a sampling direction of the multidimensional representation according to a multisampling pattern, the multisampling pattern representing a conical frustum;
generating one or more isotropic Gaussians based on the plurality of samples;
interpolating the one or more isotropic Gaussians into the one or more feature grids to produce a feature set;
providing the feature set as input to a proposal model; and
generating, based on output of the proposal model, a novel two-dimensional view of the scene.

2. The computing system of claim 1, wherein the data descriptive of one or more two-dimensional views of a scene comprises one or more images of at least a portion of the scene.

3. The computing system of claim 1, wherein the one or more feature grids comprise one or more feature grids having a first resolution and one or more feature grids having a second resolution.

4. The computing system of claim 1, wherein the one or more feature grids comprise features that approximate an integral over positional encoding of the conical frustum.

5. The computing system of claim 1, wherein the multisampling pattern comprises a number of points along one or more loops around an axis defined by the sampling direction.

6. The computing system of claim 5, wherein the multisampling pattern comprises at least one of a greater number of points or a greater number of loops at inference than at training.

7. The computing system of claim 1, wherein generating the one or more isotropic Gaussians comprises providing each of the plurality of samples as a mean of an isotropic Gaussian of the one or more isotropic Gaussians, wherein a standard deviation of the isotropic Gaussian is based on a radius of the conical frustum.

8. The computing system of claim 1, wherein interpolating the one or more isotropic Gaussians comprises downweighting the one or more isotropic Gaussians based on a scale-dependent downweighting factor.

9. The computing system of claim 8, wherein the scale-dependent downweighting factor is based on a size difference between an isotropic Gaussian of the one or more isotropic Gaussians and a size of a cell in the one or more feature grids that the isotropic Gaussian is being interpolated into.

10. The computing system of claim 1, wherein the proposal model is trained using a loss function that is smooth along the sampling direction, and wherein the loss function comprises a quadratic chi-squared loss with a stop-gradient formed by convolving a step function with a rectangular pulse.

11. A computer-implemented method for training a view generation model, the method comprising:
for each of one or more of a plurality of training iterations:
obtaining a view position of a scene within three-dimensional space;
processing data descriptive of the position with a view generation model to generate an output at a location in a novel two-dimensional view of the scene from the view position;
evaluating a loss function that compares the output to a ground-truth output, the loss function measuring a distance between a ground truth step function and a step function produced by a proposal model of the view generation model, the loss function being smooth to translation along a ray; and
modifying one or more parameter values for one or more parameters of the view generation model based at least in part on the loss function.

12. The computer-implemented method of claim 11, wherein processing data descriptive of the position with the a view generation model comprises:
obtaining a view dataset comprising data descriptive of one or more two-dimensional views of a scene;
parameterizing a multidimensional representation of the scene using one or more feature grids;
sampling a plurality of samples along a sampling direction of the multidimensional representation according to a multisampling pattern, the multisampling pattern representing a conical frustum, the sampling direction corresponding to the view position;
generating one or more isotropic Gaussians based on the plurality of samples;
interpolating the one or more isotropic Gaussians into the one or more feature grids to produce a feature set;
providing the feature set as input to a proposal model; and
generating, based on output of the proposal model, the novel two-dimensional view of the scene.

13. The computer-implemented method of claim 12, wherein the multisampling pattern comprises a number of points along one or more loops around an axis defined by the sampling direction, and wherein the number of points or a number of the one or more loops is fewer than that of a second number of points or a second number of loops at inference.

14. The computer-implemented method of claim 11, wherein the loss function comprises a step function wherein the endpoints of the step function are replaced with two signed delta functions that have been interleaved and integrated twice.

15. A computer-implemented method for generating novel two-dimensional views of a scene, the method comprising:
obtaining a view dataset comprising data descriptive of one or more two-dimensional views of a scene;
parameterizing a multidimensional representation of the scene using one or more feature grids;
sampling a plurality of samples along a sampling direction of the multidimensional representation according to a multisampling pattern, the multisampling pattern representing a conical frustum;
generating one or more isotropic Gaussians based on the plurality of samples;
interpolating the one or more isotropic Gaussians into the one or more feature grids to produce a feature set;
providing the feature set as input to a proposal model; and
generating, based on output of the proposal model, a novel two-dimensional view of the scene.

16. The computer-implemented method of claim 15, wherein the one or more feature grids comprise one or more feature grids having a first resolution and one or more feature grids having a second resolution.

17. The computer-implemented method of claim 15, wherein the one or more feature grids comprise features that approximate an integral over positional encoding of the conical frustum.

18. The computer-implemented method of claim 15, wherein the multisampling pattern comprises a number of points along one or more loops around an axis defined by the sampling direction.

19. The computer-implemented method of claim 15, wherein generating the one or more isotropic Gaussians comprises providing each of the plurality of samples as a mean of an isotropic Gaussian of the one or more isotropic Gaussians, wherein a standard deviation of the isotropic Gaussian is based on a radius of the conical frustum.

20. The computer-implemented method of claim 15, wherein interpolating the one or more isotropic Gaussians comprises downweighting the one or more isotropic Gaussians based on a scale-dependent downweighing factor, and wherein the scale-dependent downweighting factor is based on a size difference between an isotropic Gaussian of the one or more isotropic Gaussians and a size of a cell in the one or more feature grids that the isotropic Gaussian is being interpolated into.
